(19) United States
(12) Patent Application Publication
(10) Pub. No.: US 2007/0064914 A1
(43) Pub. Date: Mar. 22, 2007

(54) Method for notifying customers of an agent's progress in fulfilling work orders

(75) Inventors: Bennett Seyer, Ballwin, MO (US); Erik Manning, Edwardsville, IL (US); Kerry Shireman, Grain Valley, MO (US); Mo Katibeh, Houston, TX (US); Keith G. Bruns, N. Little Rock, AR (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/227,057

(22) Filed: Sep. 15, 2005

(51) Int. Cl. H04M 3/00; H04M 5/00

(52) U.S. Cl. 379/265.06

(57) ABSTRACT

A system and method are disclosed for notifying customers of an agent's progress in fulfilling work orders. A system that incorporates teachings of the present disclosure may include, for example, an account management system (AMS) (100) having a communications interface (110), a memory (104), and a controller (102). The controller is programmed to submit (208) to an agent a work order corresponding to a service request of a customer (108), and submit (222) to the customer at predetermined intervals by electronic means progressive updates of the agent's progress in fulfilling the work order.

### FIELD OF THE DISCLOSURE

The present disclosure relates generally to work order notification techniques, and more specifically to a method for notifying customers of an agent's progress in fulfilling work orders.

### BACKGROUND

Most service providers today provide customers vague information as to the completion of a work order. Often customers are given an indefinite range of time for the completion of a work order, such as for example, between 1-5 PM on a particular day, or worse yet, sometime in the next several days. When the customer needs to be at his/her premises to provide entry to a service agent, such unclear projections can be very frustrating to the customer, especially when the customer has to take time off from work.

### BRIEF DESCRIPTION OF THE DRAWINGS

FIG. 1 is a block diagram of an account management system (AMS) coupled to a communications network for serving a party's needs according to the teachings of the present disclosure;

FIG. 2 depicts a flowchart of a method operating in the AMS incorporating teachings of the present disclosure; and

FIG. 3 is a diagrammatic representation of a machine in the form of a computer system within which a set of instructions, when executed, may cause the machine to perform any one or more of the methodologies discussed herein.

### DETAILED DESCRIPTION OF THE DRAWINGS

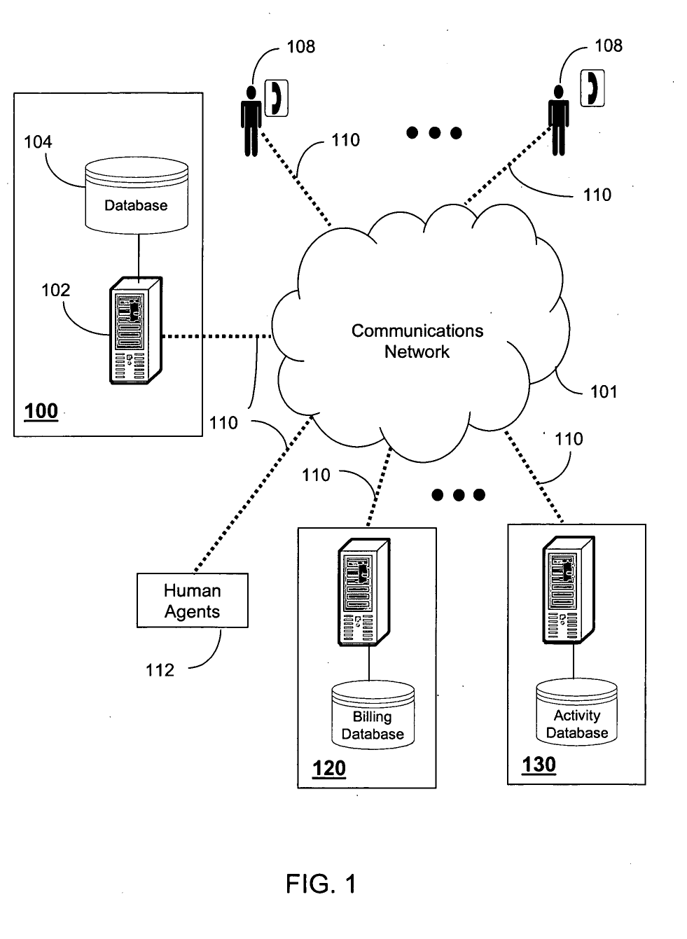

FIG. 1 is a block diagram of an account management system (AMS) 100 coupled to a communications network 101 for serving a party's needs according to teachings of the present disclosure. A party in the present context can be any individual whether or not interacting with the individual is in a commercial setting. For illustration purposes only, a party will be herein referred to as a customer. The AMS 100 comprises a communications interface 110, a memory 104 and a controller 102. The communications interface 110 utilizes wired or wireless communications technology for interfacing to the communications network 101. The communications interface 110 can represent a circuit switched and/or a packet switched interface.

In the present illustration, services provided to a customer 108 include Internet or traditional voice services via the network 101. Thus, for example, the communications network 101 can offer multiple services such as: POTS (Plain Old Telephone Service), VoIP (Voice over Internet communications, IPTV (Internet Protocol Television), broadband communications, cellular telephony, and other known or future communication services.

It would be apparent to one of ordinary skill in art that the present disclosure can be applied to other service contexts such as, for example, requesting repair or installation service for plumbing, residential or commercial appliances, and so on. Although not described below, any service context can be applied to the present disclosure.

Referring to FIG. 1, the controller 102 utilizes computing technology such as a desktop computer, or a scalable server. The memory 104 utilizes mass storage media such as a high capacity disk drive that can be used by the controller 102 to manage one or more databases in accordance with the present disclosure. The AMS 100 can also use applications such as an IVR (Interactive Voice Response) application, and/or a CRM (Customer Relations Management) application for interacting with customers 108 and managing account information, respectively.

By way of the communications interface 110, the AMS 100 can access independently operated remote systems such as a billing system 120 and/or an activity-based tracking system 130 that can provide information such as service agent work order updates, and other relevant information pertaining to operations of network 101. The AMS 100 can also perform updates on, for example, the billing system 120 as it processes customer calls in accordance with the present disclosure. It will be appreciated that in the alternative the remote systems 120 and 130 can be in whole or in part an integral part of the AMS 100. The AMS 100 can also direct customer exchanges to a service center with one or more human agents 112 and/or an IVR.

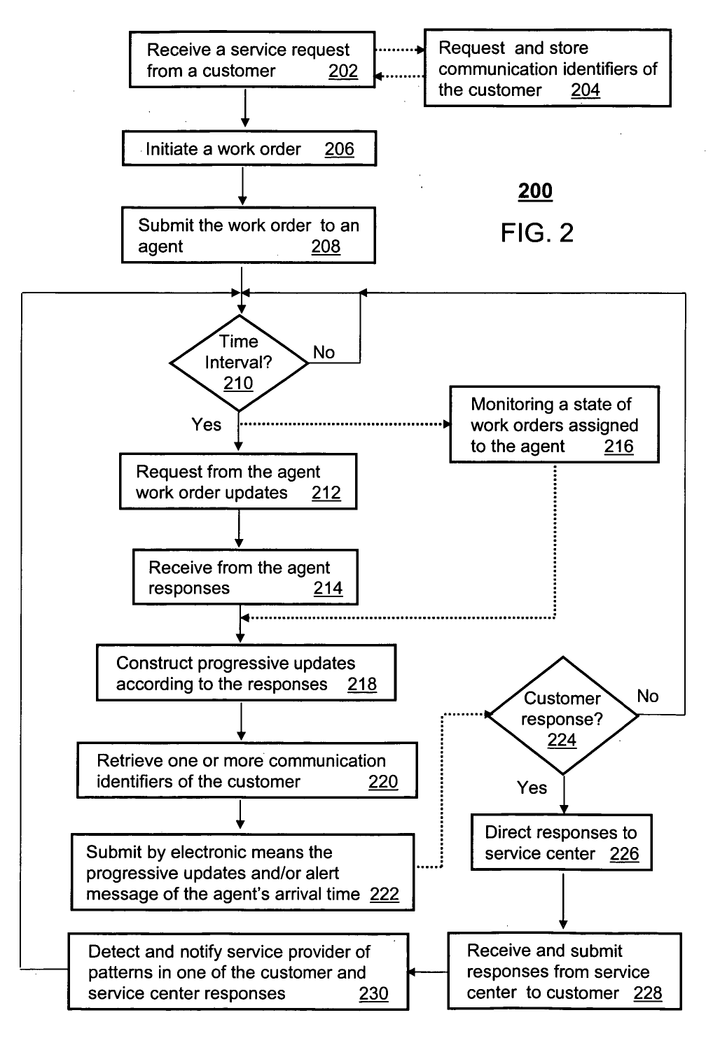

FIG. 2 depicts a flowchart of a method 200 operating in the AMS 100 incorporating teachings of the present disclosure. Method 200 begins with step 202 where the AMS 100 is programmed to receive a service request from a customer 108. The service request can be, for instance, an installation request for new service (e.g., cable TV, DSL, etc.), or a repair request (e.g., cable service is malfunctioning). If a customer communication identifier is not available for the customer in system 120, the AMS 100 can proceed to step 204 where it requests and stores said information. A communication identifier can include an email address, a cell phone number, a plain old telephone service (POTS) phone number, a VoIP (Voice over IP) phone number, or any other identifier for communicating with the customer. A web page can also be associated with the customer's account, so as to provide the customer a means for checking work order updates.

The AMS creates a work order in step 206 corresponding to the service request. The work order is then submitted to an agent of the service provider in step 208. The agent can represent, for example, field personnel in cases where the work order must be performed at the customer's premises. Alternatively, the agent can be a technician who provides the customer support via a telephonic exchange. The order can be submitted to the agent by means such email, a CRM update, or over-the-air (OTA) messages to a portable unit carried by the agent for receiving work orders, and so on.

In step 210, the AMS 100 can be programmed to request and receive in steps 212 and 214, respectively, at predetermined intervals (e.g., once every hour) work order updates from the agent, or monitor in step 216 a state of work orders assigned to the agent. Either of these embodiments can be automated or can be performed manually by a service agent. For example, for field service agents, the request can be received by a portable unit of the agent which prompts the agent by way of, for example, through a GUI (Graphical User Interface) for an update on one or more work orders. The prompt can include canned responses such as a selection of expected work order completion times (10, 15, or 30 minutes), a selection indicating that the work order has been completed, a selection indicating that it is unclear when work order will be completed, and so on. The agent's responses are then recorded in a database (such as a CRM) of the AMS 100. Alternatively, the service agent may be called by personnel of the service provider and asked for a status, which is then entered into the database of the AMS 100 by service personnel.

In yet a more sophisticated embodiment, the interaction with the service agent can entail an automated process such as in step 216 where the AMS 100 can be programmed to communicate with, for example, a remote portable device carried by the agent (capable of OTA communications via network 101) that can be monitored for a change in the status of work orders. The agent simply enters work order updates as each task is completed in a format defined by the service provider (e.g., time work order was started, time work order was completed, estimated time of arrival at next work order, etc.). Work order updates can thus be monitored in step 216 according to these formats.

In step 218, the AMS 100 is programmed to construct progressive updates according to the responses provided in steps 212-216. Progressive updates can include status information such as, for example, the number of work orders completed by the agent, a number of uncompleted work orders remaining, an average time of completion between work orders, an estimated time of arrival at the customer's premises based on the agent's progress between work orders, and/or an estimated time for completing the customer's work order. Any one or more of these status updates can be periodically submitted to the customer to keep the customer informed of the agent's progress towards fulfilling the customer's work order.

Once a progressive update has been assembled, the AMS 100 proceeds to step 220 where one or more communication identifiers of the customer is retrieved from the database 104 of the AMS 100. In step 222, the progressive update is submitted by electronic means to update the customer on the progress of the work order. In this step, the customer can also be alerted with a message that indicates when the agent will arrive at the customer's premises to process the work order. This latter embodiment can afford the customer the convenience to run errands while awaiting the service agent's arrival.

The electronic means can represent, for example, an over-the-air (OTA) communication medium, or a wired communication medium coupled to the AMS 100 by way of the communications interface 110. The progressive updates can be incorporated in one or more of a group of message types including, but not limited to, an email, a Short Message System (SMS) message, a voice message, or a web page accessible from the Internet. The voice message can be, for example, a synthesized message from an IVR application of the AMS 100, or a synthesized voice message packetized and transmitted by wired or wireless means to a communication device corresponding to the communication identifier of the customer. The customer can either listen to the message upon arrival, or the device can store the synthesized voice message which is played later upon request (similar to a voice message).

In a supplemental embodiment, the AMS 100 can also check in step 224 for responses from the customer such as email, or canned responses that the AMS 100 can readily recognize. If no response is detected, the AMS 100 proceeds to step 210 where it repeats portions of method 200 to progressively update the customer. If a customer response is detected in step 224, the response is directed to a service center. The customer's response can be an email with, for example, a request for a change in time to process the work order, or an inquiry regarding the progressive updates. Alternatively, the customer's response can be any number of canned responses understood by the AMS 100.

In an embodiment where the customer's response is an un-canned email, a human agent 112 associated with the service center can be assigned to process the email. The service agent 112 can in turn submit a service center response by email. Said response can be intercepted and submitted by the AMS 100 to the customer 108 by the same electronic means as in step 222. If, on the other hand, the customer response is based on a canned message, the AMS 100 can serve as the service center and automatically process and respond to the customer's message with any number of responses programmed by the service provider to respond to canned customer messages.

For quality assurance, the AMS 100 can be further programmed in step 230 to detect patterns in the exchanges between the customer and the service provider. If a pattern is detected, the service provider can be notified of said patterns. The service provider can then analyze these patterns, make adjustments to the AMS 100, and/or adjustments to the operating policy used by the human agents 112 to improve overall customer service.

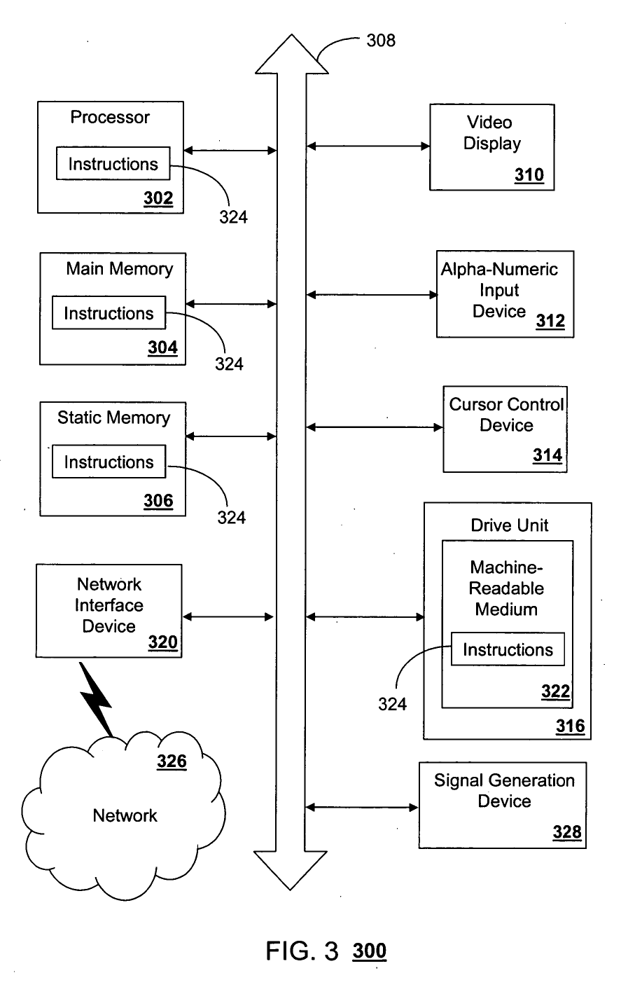

FIG. 3 is a diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated in herein above. The instructions 324 may also reside, completely or at least partially, within the main memory 304, the static memory 306, and/or within the processor 302 during execution thereof by the computer system 300. The main memory 304 and the processor 302 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to email or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
initiating a work order for a customer;
submitting the work order to an agent of a service provider; and
submitting to the customer by electronic means progressive updates of the agent's progress in fulfilling the work order.

2. The storage medium of claim 1, comprising computer instructions for:
receiving from the agent work order updates at a plurality of time intervals; and
constructing progressive updates according to the work order updates.

3. The storage medium of claim 1, comprising computer instructions for:
requesting one or more communication identifiers from the customer; and
storing one or more communication identifiers supplied by the customer.

4. The storage medium of claim 3, comprising computer instructions for:
retrieving one or more communication identifiers corresponding to the customer; and
submitting by electronic means the progressive updates at predetermined intervals according to the communication identifiers.

5. The storage medium of claim 1, comprising computer instructions for submitting the progressive updates on at least one among a group of electronic means comprising an over-the-air (OTA) communication medium, and a wired communication medium, wherein the progressive updates are incorporated in at least one among a group of message types comprising an email, a Short Message System (SMS) message, a voice message, and a web page accessible from the Internet.

6. The storage medium of claim 1, comprising computer instructions for:
monitoring at predetermined intervals a state of one or more work orders assigned to the agent;
constructing the progressive updates according to the monitored state of the one or more work orders; and
submitting the progressive updates to the customer at one or more of the predetermined intervals.

7. The storage medium of claim 1, comprising computer instructions for:
receiving by electronic means one or more messages from the customer in response to one or more progressive updates submitted to said customer; and
directing said customer messages to a service center.

8. The storage medium of claim 7, comprising computer instructions for:
receiving from the service center one or more responses corresponding to the one or more messages of the customer; and
submitting by electronic means said one or more responses to the customer.

9. The storage medium of claim 7, comprising computer instructions for:
identifying one or more patterns in the one or more messages; and
notifying the service provider of said patterns.

10. The storage medium of claim 1, comprising computer instructions for submitting an alert message to the customer indicating when the agent will arrive at the premises of the customer to process the work order.

11. The storage medium of claim 1, wherein the work order is at least one among an installation request and a repair request.

12. A method, comprising the steps of:
receiving a service request from a party;
submitting to an agent a work order corresponding to the service request;
retrieving one or more communication identifiers corresponding to the party; and
submitting to the party, at predetermined intervals by electronic means according to the communication identifiers corresponding to the party, progressive updates of the agent's progress in fulfilling the work order.

13. The method of claim 12, comprising the steps of:
requesting from the agent work order updates at a plurality of time intervals;
receiving from the agent one or more responses corresponding to the request; and
constructing progressive updates according to said one or more responses.

14. The method of claim 12, comprising the step of submitting the progressive updates on at least one among a group of electronic means comprising an over-the-air (OTA) communication medium, and a wired communication medium, wherein the progressive updates are incorporated in at least one among a group of message types comprising an email, a Short Message System (SMS) message, a voice message, and a web page accessible from the Internet.

15. The method of claim 12, comprising the steps of:
receiving by electronic means one or more messages from the party in response to one or more progressive updates;
directing said one or more messages to a service center;
submitting from the service center one or more responses; and
submitting by electronic means said one or more responses to the party.

16. The method of claim 12, wherein progressive updates include one or more among a group of updates comprising a number of work orders completed by the agent, a number of uncompleted work orders remaining, an average time of completion between work orders, an estimated time of arrival at the party's premises based on the agent's progress between work orders, and an estimated time for completing the party's work order.

17. The method of claim 12, comprising the step of submitting an alert message by electronic means to the party indicating when presence of the party is required at the party's premise to provide access to the agent for processing the work order.

18. An account management system (AMS), comprising:
a communications interface;
a memory; and
a controller programmed to:
submit to an agent a work order corresponding to a service request of a customer; and
submit to the customer by electronic means at predetermined intervals progressive updates of the agent's progress in fulfilling the work order.

19. The AMS of claim 18, wherein the controller is programmed to:
request from the agent work order updates at predetermined intervals;
construct progressive updates according to the work order updates;
submit by electronic means the progressive updates to the customer at one or more of the predetermined intervals;
receive by electronic means one or more messages from the customer in response to one or more progressive updates;
direct said messages to one or more personnel of the service center; and
submit by electronic means to the customer one or more responses from said service center.

20. The AMS of claim 18, wherein the controller is programmed to submit an alert message by electronic means to the customer indicating when the agent will arrive at the premises of the customer to process the work order.
